(19) United States
(12) Patent Application Publication
(10) Pub. No.: US 2016/0132853 A1
(43) Pub. Date: May 12, 2016

(54) REMOTE AUTHENTICATION FOR POINT OF SALE MACHINE USING A MOBILE NUMBER THROUGH UNSTRUCTURED SUPPLEMENTARY SERVICE DATA

(71) Applicant: INTERNATIONAL BUSINESS MACHINES CORPORATION, Armonk, NY (US)

(72) Inventors: Saurabh Kumar, Muzaffarpur (IN); Dharmendra Nahar, Sonkatchh (IN)

(21) Appl. No.: 14/538,256

(22) Filed: Nov. 11, 2014

(51) Int. Cl. G06Q 20/20; G06Q 20/32; G06Q 20/38; G06Q 20/40

(52) U.S. Cl. CPC G06Q 20/206; G06Q 20/40; G06Q 20/3226; G06Q 20/385

(57) ABSTRACT

Remotely authenticating an invoice amount for a sales transaction with a merchant through a mobile device of a user using a USSD session initiated by a telecom service provider. The provider receives a transaction request of at least a mobile phone number and invoice amount from a POS machine at the merchant. The provider identifies the user from the mobile number and generates a one-time purchase ID associated with the invoice and sends the purchase ID to the user through the mobile device. The provider initiates an interactive USSD session with the user through a gateway and sends a menu with transaction details and financial account list on the user's mobile device within the session including multiple financial accounts registered to the user. The provider receives a password from the user through the session and deducts the invoice amount from a user's account and transfers the funds to the merchant.

### BACKGROUND

The present invention relates to remote authentication of transactions through point of sale machines, and more specifically to remote authentication of transactions through for point of sale machines using a mobile number through unstructured supplementary service data to choose between multiple financial accounts.

Transactions within a retail store are carried out through a point of sale (POS) machine using a credit card or debit card of a customer. In order for the customer to make a purchase, the customer must have the debit card or credit card at the retail store. If the customer uses the debit card to make a purchase, the customer has to enter their secret personal identification number (PIN) on the POS machine in front of the merchant, exposing their secret PIN to multiple people. Every time the credit card and debit cards of a customer are used they are exposed to possible credit card fraud, encompassing theft and fraud committed using or involving a payment card as a fraudulent source of funds within a transaction, by both by the people involved with the transactions and the data the retail store may obtain in authenticating and completing the transaction.

Some solutions allow a customer to pay for goods and services in a retail store using their smart phones, which requires both access to the Internet and/or a special application specifically open on the smart phone. The details of the transaction are forwarded to the user's mobile device and the user authenticates the transaction using a unique personal identification number (PIN) associated with the user. The user authentication takes place by a short message service (SMS) request and response with the user providing the PIN or password in response. Alternatively, authentication of the transaction takes place through short message hypertext transfer protocol (HTTP).

The prior art systems, which use SMS and HTTP authentication, do not allow any choice of a specific money account to withdraw the funds for the transaction. Instead, the prior art systems merely require an indication of approval of the transaction sent from the user to the mobile provider. Furthermore, without the ability to specify alternate accounts, if insufficient funds are present within the money account or monies for the transaction, the transaction will be terminated, since only one source of funds is present.

Alternatively, in other solutions, a user has to dial a specific code to access their telecom service provider and enter a password through an unstructured supplementary service data (USSD) menu. This solution is available for online shopping or fund transfer.

Some smart phone applications provide a wallet system which stores digital images of multiple credit/debit cards, however, these systems do not provide account selection in real time. Once a transaction has failed to complete from one account, the session terminates with an error code. These wallet systems are primarily used for online shopping or require additional phone features to carry out transaction in shops, such as near field communication (NFC).

### SUMMARY

According to one embodiment of the present invention, a method of a user remotely authenticating an invoice amount for a sales transaction with a merchant through a mobile device using an unstructured supplementary service data session initiated by a telecom service provider. The method comprising the steps of: the telecom service provider receiving a transaction request comprising at least a mobile phone number and the invoice amount from a point of sale machine at the merchant; the telecom service provider identifying the user from the mobile phone number received; the telecom service provider generating a one-time purchase identification associated with the invoice and sending the one-time purchase identification to the user through the mobile device; the telecom service provider initiating an interactive unstructured supplementary service data session with the user through a gateway; the telecom service provider sending a menu with transaction details on the user's mobile device through the data session; the telecom service provider receiving a password from the user through the unstructured supplementary service data session, deducting the invoice amount from a financial account associated with the user and transferring the invoice amount to a financial account associated with the merchant; and the telecom service provider sending an acknowledgement of payment of the invoice to the point of sale machine.

According to another embodiment of the present invention a computer system for a user to remotely authenticating an invoice amount for a sales transaction with a merchant through a mobile device using an unstructured supplementary service data session initiated by a telecom service provider. The telecom service provider comprising: at least one processor, one or more memories, one or more computer readable storage media, the computer program product comprising a computer readable storage medium having program instructions embodied therewith, the program instructions executable by the computer to perform a method comprising: receiving, by the telecom service provider computer, a transaction request comprising at least a mobile phone number and the invoice amount from a point of sale machine at the merchant; identifying, by the telecom service provider computer, the user from the mobile phone number received; generating, by the telecom service provider computer, a one-time purchase identification associated with the invoice and sending the one-time purchase identification to the user through the mobile device; initiating, by the telecom service provider computer, an interactive unstructured supplementary service data session with the user through a gateway; sending, by the telecom service provider computer, a menu with transaction details on the user's mobile device through the unstructured supplementary service data session; receiving, by the telecom service provider computer, a password from the user through the unstructured supplementary service data session, deducting the invoice amount from a financial account associated with the user and transferring the invoice amount to a financial account associated with the merchant; and sending, by the telecom service provider computer, an acknowledgement of payment of the invoice to the point of sale machine.

According to another embodiment of the present invention a computer program product for a user to remotely authenticating an invoice amount for a sales transaction with a merchant through a mobile device using an unstructured supplementary service data session initiated by a telecom service provider. The telecom service provider comprising a telecom service provider computer comprising a telecom service provider computer comprising at least one processor, one or more memories, one or more computer readable storage media having program instructions executable by the computer to perform the program instructions comprising: receiving, by the telecom service provider computer, a transaction request comprising at least a mobile phone number and the invoice amount from a point of sale machine at the merchant; identifying, by the telecom service provider computer, the user from the mobile phone number received; generating, by the telecom service provider computer, a one-time purchase identification associated with the invoice and sending the one-time purchase identification to the user through the mobile device; initiating, by the telecom service provider computer, an interactive unstructured supplementary service data session with the user through a gateway; sending, by the telecom service provider computer, a menu with transaction details on the user's mobile device through the unstructured supplementary service data session; receiving, by the telecom service provider computer, a password from the user through the data session, deducting the invoice amount from a financial account associated with the user and transferring the invoice amount to a financial account associated with the merchant; and sending, by the telecom service provider computer, an acknowledgement of payment of the invoice to the point of sale machine.

The menu with the transaction details provided to the user's mobile device through the unstructured supplementary service data session in the above embodiments preferably includes multiple financial accounts associated with the mobile number of the user in which the user can choose which account funds can be transferred to the merchant for the invoice amount.

### BRIEF DESCRIPTION OF THE SEVERAL VIEWS OF THE DRAWINGS

FIG. 1 shows depicts an exemplary diagram of a possible data processing environment in which illustrative embodiments may be implemented.

FIG. 2 shows a schematic of how the USSD menu is sent to a mobile device.

FIG. 3 shows a schematic of an interaction of a customer with a telecom service provider for purchasing of goods from a merchant in a first embodiment.

FIG. 4 shows a schematic of the interaction of a customer with a telecom service provider for purchasing of goods from a merchant through another customer in a second embodiment.

FIG. 5 shows an overview of the communication between a merchant, a user or customer, the telecom service provider, the POS machine of a merchant and the customer's registered financial accounts.

FIG. 6 shows the communication between the telecom service provider and multiple money financials associated with a single customer.

FIG. 7 shows a schematic of timeline of events that takes place during the method of remote authentication for point of sale machine using a mobile number through unstructured supplementary service data.

FIG. 8 shows a flow diagram of a method of remote authentication for point of sale (POS) machine using a mobile number.

FIG. 9 shows a flow diagram of a method of obtaining remote authentication of a transaction through the telecom service provider.

FIG. 10 shows a flow diagram of a method of remote authentication of a transaction through the customer's mobile phone using unstructured supplementary service data.

FIG. 11 illustrates internal and external components of a client or device computer and a server computer in which illustrative embodiments may be implemented.

### DETAILED DESCRIPTION

In an illustrated embodiment of the present invention, it is recognized that unstructured supplementary service data (USSD) is a more secured way of communication than SMS as there is no data stored in a user's mobile device and the transmission channel may be further secured by encryption. SMS can also be significantly delayed if synchronization is lost.

USSD protocol establishes communication between a mobile user and a telecom service provider, such as a telephone company (Telco). USSD messages create a real-time connection during a USSD session. The connection remains open, allowing a two-way exchange of a sequence of data. During the USSD session, a menu driven application can be used to list the financial accounts attached by the mobile user to their mobile number, allowing the user to select any financial account through the menu. The user can then authenticate the transaction through the telecom service provider, with the telecom service provider carrying out the transaction with the chosen financial account. The user authenticates this transaction through a permanent password.

A USSD gateway, a collection of hardware and software to interconnect two or more disparate networks, routes USSD messages between a telecom service provider and a a menu-driven service on the user's phone. The USSD gateway acts as a server for request and response between the user and the telecom service provider. Once the request and response between the user and the telecom service provider is complete, the connection between the telecom service provider and the user through the USSD gateway is destroyed.

It should be noted that the difference between USSD gateways and messaging gateways is the following: a USSD gateway maintains a single interactive session between the telecom service provider's computer and the user's mobile device once the connection is established through the USSD gateway, so that the user is effectively interacting directly in real time with the telecom service provider. SMS and multimedia messaging service (MMS), on the other hand, store and forward messages from the merchant to the user and back again, similar to the way email is sent over the Internet, requiring a wait each time a message is sent. The dialogue can be interrupted due to a delay in response in delivering the SMS message or if the SMS message is lost. This difference is analogous to calling the merchant and placing an order with a clerk as opposed to communicating back and forth by mail order.

USSD services can be accessed from any country in the world. All USSD requests are routed back to the user's home network with help of a home location register (HLR). Dialing a USSD code while the user is “roaming” through another network will connect the user through a gateway which is in the user's home network. This helps users to access the service from other countries.

With USSD, users get the feeling using a mobile phone application on the phone, rather than accessing a remote computer server. USSD doesn't require any installation and works on any phone, regardless of whether the phone is a smartphone or not. Further, using USSD does not require SMS, mobile applications, third generation (3G) telecommunication networks, near field communication, or general packet radio service

By using USSD service for user authentication, the chances of hacking are reduced. Since a user no longer needs to carry a debit or credit card to retail shops, the risk of forgery is decreased significantly. Furthermore, any person can shop on a user's behalf, as the system is based on remote authentication.

In an illustrated embodiment of the present invention, it is recognized that USSD permits multiple transactions to be initiated by the user from the same or different POS machine, and while the user is interacting on one transaction, such additional transactions can be cancelled or placed “on hold” in real time. It should be noted that the POS machines itself is not prevented from continuing to process sales for new customers when transactions for other users are placed “on hold”.

In an illustrated embodiment of the present invention, it is recognized that a one-time purchase identification (ID) is a randomly generated number which is valid for one transaction only. The one-time purchase ID can be used as a unique transaction identifier and may be equivalent to the transaction number of the merchant. The one-time purchase ID is used for transaction identification. A “ permanent password” in this application is called as a defined password which the user has registered with their telecom service provider for all transaction associated with the registered mobile number. The password is known to the user and the telecom service provider. The password is required from the user in order for money to be deducted for a transaction associated with a one-time purchase ID.

In an illustrated embodiment of the present invention, it is recognized that multiple financial accounts may be associated with a mobile number, reducing the burden on the user of the mobile device from having to remember multiple account numbers. If sufficient funds are not present in a financial account associated with the mobile number for a transaction, the financial account may be changed to another account registered to the user's mobile phone number in real time within a USSD menu.

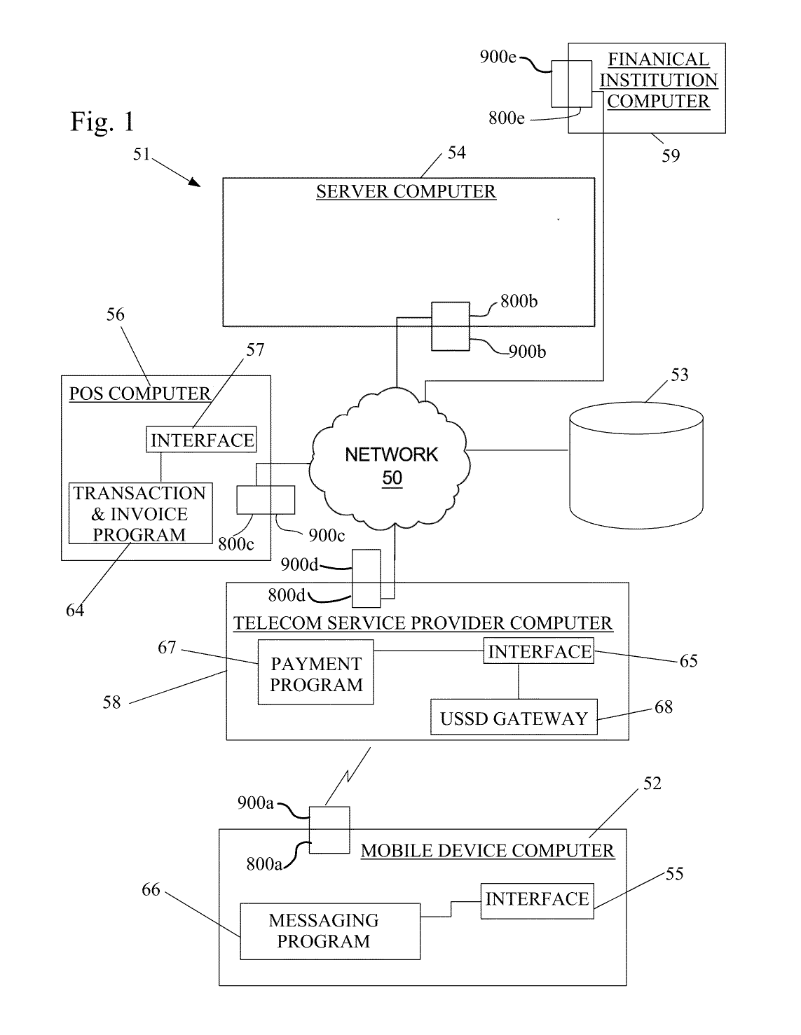

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

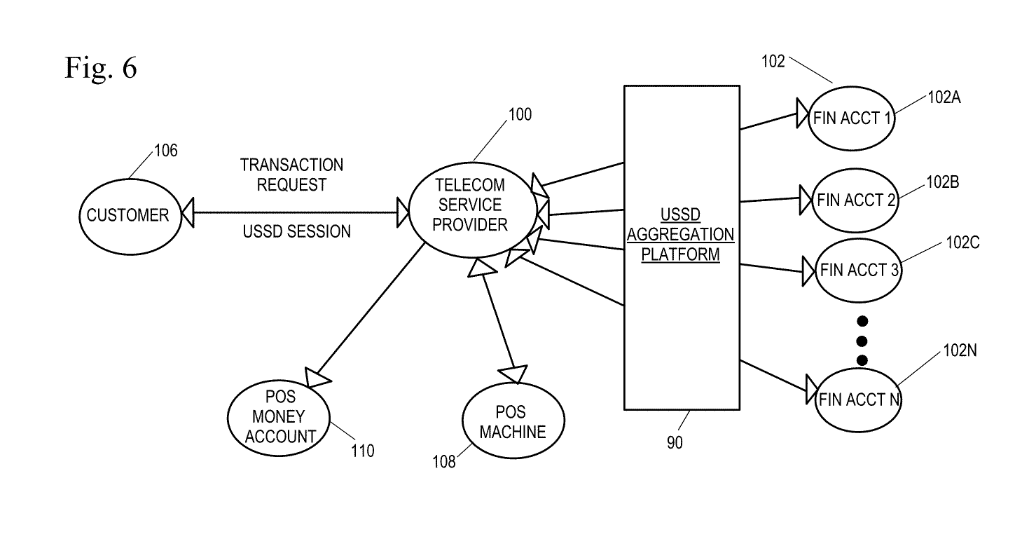

In the depicted example, a POS computer 56, a repository 53, a server computer 54, a financial institution computer 59, and a telecom service provider 58 connect to network 50. A mobile device computer 52 connects to the network 50 through the telecom service provider 58. The financial institution computer 59 connects to the telecom service provider 58 through a USSD aggregation platform (not shown - see FIG. 6). In other exemplary embodiments, network data processing system 51 may include additional client or device computers, storage devices or repositories, server computers, and other devices not shown.

Mobile device computer 52 may be, for example, a mobile device, a cell phone, a personal digital assistant, a netbook, a laptop computer, a tablet computer, a desktop computer, or any other type of computing device.

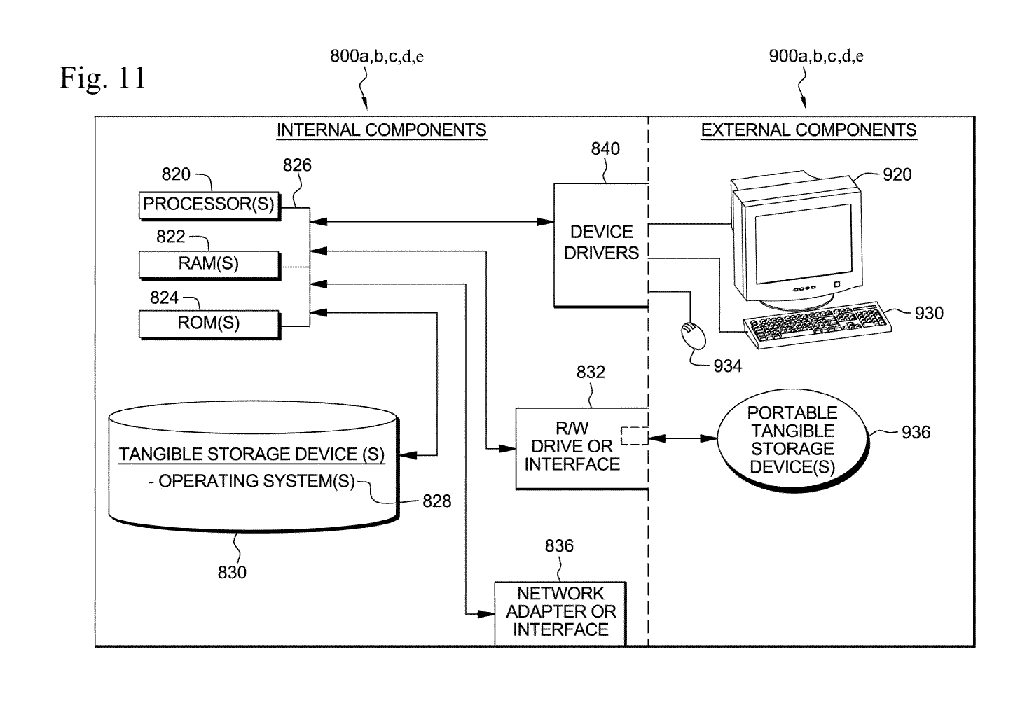

Mobile device computer 52 may contain an interface 55. The interface 55 may accept commands and data entry from a user, such as user preferences and passwords to authenticate a transaction. The interface 55 can be, for example, a command line interface, a graphical user interface (GUI), or a web user interface (WUI). The device computer 52 preferably includes a messaging program 66. Mobile device computer 52 includes a set of internal components 800a and a set of external components 900a, further illustrated in FIG. 11.

POS computer 56 may be, for example a POS machine or other type of computing device that can be used for invoicing a customer such as a checkout terminal or register, hand held electronic point of sale (E-POS) machine, or merchant billing system. POS computer 56 may contain an interface 57. The interface 57 may accept commands and data entry from a user, such as invoice total, mobile phone numbers, or other details regarding a monetary transaction or receiving payment for the monetary transaction. The interface 57 can be, for example, a command line interface, a graphical user interface (GUI), or a web user interface (WUI). The POS computer 56 preferably includes a transaction and invoice program 64. While not shown, it may be desirable to have the transaction and invoice program 64 be present on the server computer 54. POS computer 56 includes a set of internal components 800c and a set of external components 900c, further illustrated in FIG. 11.

The telecom service provider 58 may include a collection of hardware and software and includes a set of internal components 800d and a set of external components 900d illustrated in FIG. 11. The telecom service provider 58 may contain an interface 65. The interface 65 may accept commands, data entry, and input from a telecom service provider, for example a telephone company (Telco). The interface 65 can be, for example, a command line interface, a graphical user interface (GUI), or a web user interface (WUI). The telecom service provider 58 also preferably includes a payment program 67 and a USSD Gateway 68. The telecom service provider 58 is in communication with the mobile device computer 52.

The financial institution computer 59 includes a set of internal components 800e and a set of external components 900e illustrated in FIG. 11. The financial institution computer 59 is connected to the telecom service provider. The financial institution computer 59 connects to the telecom service provider 58 and the mobile device computer 52 through a USSD aggregation platform. The financial institution computer 59 may be representative of multiple banks or multiple mobile account currency, or any other financial institution which provides a facility for the storage of money.

Server computer 54 includes a set of internal components 800b and a set of external components 900b illustrated in FIG. 11. In the depicted example, server computer 54 provides information, such as boot files, operating system images, and applications to mobile device computer 52, POS computer 56, and the telecom service provider 55. Server computer 54 can compute the information locally or extract the information from other computers on network 50.

Program code and programs such as a messaging program 66, a USSD gateway 68, a transaction and invoice program 64, and a payment program 67 may be stored on at least one of one or more computer-readable tangible storage devices 830 shown in FIG. 11, on at least one of one or more portable computer-readable tangible storage devices 936 as shown in FIG. 11, on repository 53 connected to network 50, or downloaded to a data processing system or other device for use. For example, program code and programs such as a messaging program 66, a transaction and invoice program 64, and a payment program 67 may be stored on at least one of one or more tangible storage devices 830 on server computer 54 and downloaded to the mobile device computer 52 and/or POS computer 56. Alternatively, server computer 54 can be a web server, and the program code and programs such as a messaging program 66, a transaction and invoice program 64, and a payment program 67 may be stored on at least one of the one or more tangible storage devices 830 on server computer 54 and accessed on the device computer 52 and POS computer 56 through interfaces 55 and 57 respectively. In other exemplary embodiments, the program code and programs such as a messaging program 66, a transaction and invoice program 64, and a payment program 67 may be stored on at least one of one or more computer-readable tangible storage devices 830 on server computer 54 or distributed between two or more servers. The USSD gateway 68 may also be stored on at least one of one or more computer-readable tangible storage devices 830 on server computer 54 or distributed between two or more servers.

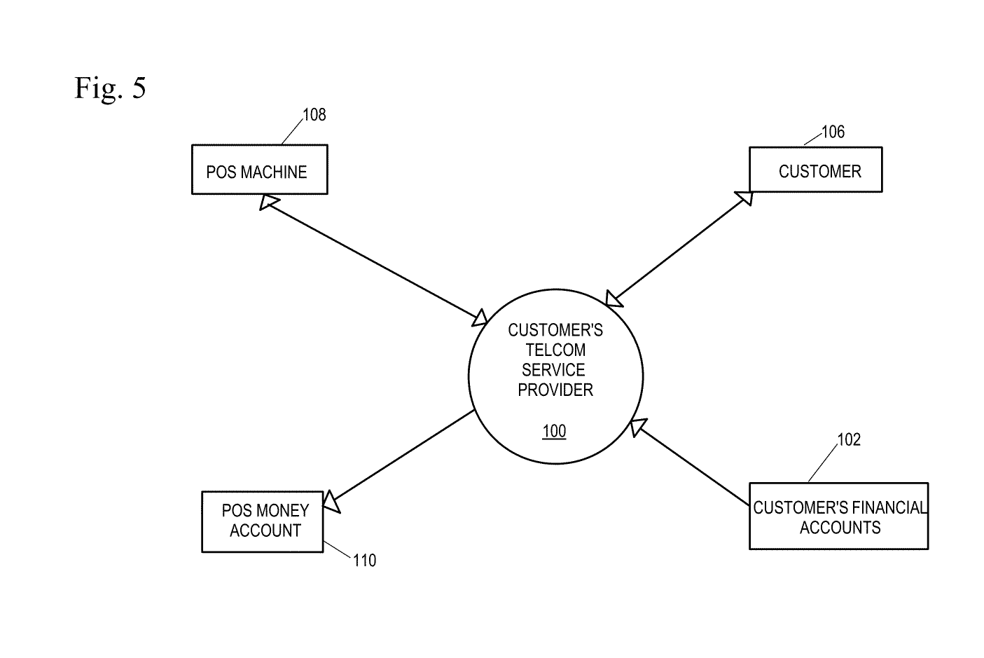

FIG. 5 shows an overview of the communication between a merchant, a user or customer, the telecom service provider, the POS machine of a merchant and the customer's registered financial accounts. A POS machine 108 and a POS money account 110 of at least one merchant are in communication with their customer's telecom service provider 100. The telecom service provider 100 is also in communication with their customers or subscribers 106 and the customers' or subscribers' registered financial or money accounts 102.

FIG. 6 shows the communication between the telecom service provider and multiple financial accounts of a single customer. A customer 106 can register multiple financial accounts 102a-102n with a telecom service provider 100 to draw funds in response to an invoice from a POS machine 108 of a merchant, to be transferred to the POS money account 110 of the merchant. The customer 106 is provided with the invoice amount through a USSD session initiated between the telecom service provider 100 and the user's mobile device 52. The USSD aggregation platform 90 provides a platform for communication between multiple banks or financial institutions and the telecom service provider. The USSD aggregation platform 90 may be based on any protocol, such as a HTTP, simple mail transfer protocol (SMTP), simple access object protocol (SOAP), direct interaction with database (DB interface) or some other protocol.

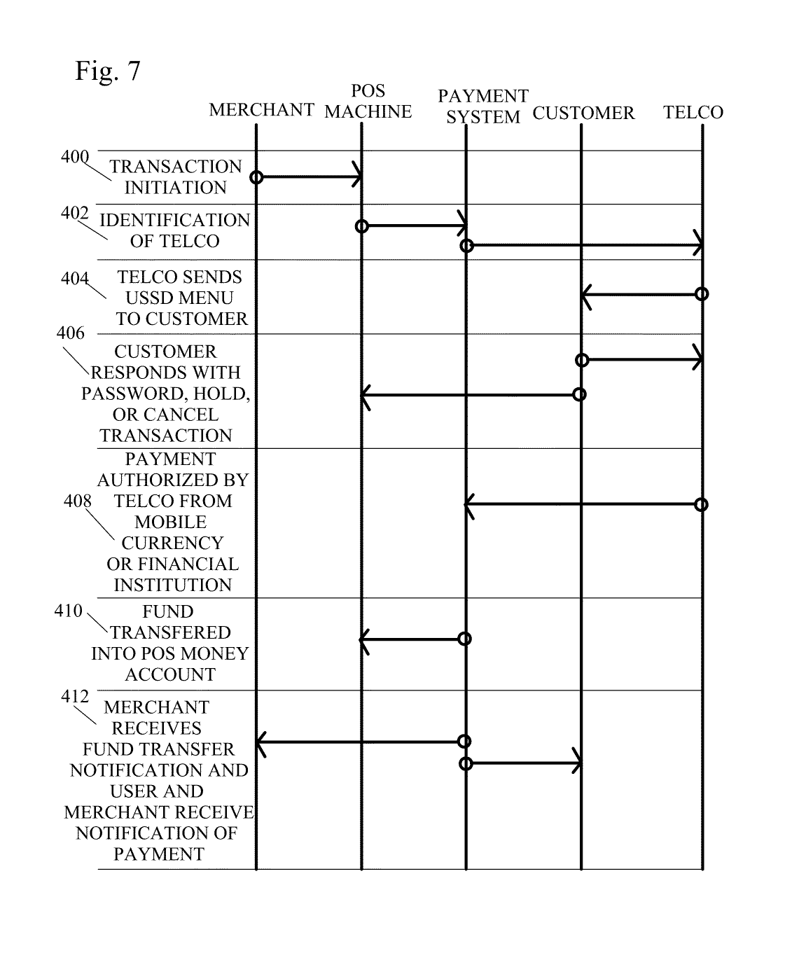

FIG. 7 shows a schematic of timeline of events that takes place during the method of remote authentication for a point of sale (POS) machine using a mobile number through unstructured supplementary service data (USSD).

A transaction is initiated 400 by a merchant by entering in an invoice amount and mobile number of customer 106 through a keypad, touch screen or any other interface for user input, of a POS machine 108. The POS machine 108 sends a request to a merchant's payment system to identify the customer's telecom service provider (TELCO) from the mobile number entered and then sends at least an invoice amount and mobile number of the customer to the identified telecom service provider 402.

The telecom service provider sends a USSD menu to the customer associated with the mobile number 404 with transaction details and asks for a password.

The customer associated with the mobile number responds with the password, places the transaction on hold, or to cancel the transaction which is sent to the POS machine through the telecom service provider 406. If the user rejects the transaction a notification is sent to the POS machine.

If the transaction is placed on hold, a notice is sent to the merchant and the merchant based on their allowed hold time either waits, or cancels the transaction. To handle a queue of transactions on a POS machine, connection between the telecom service provider and the merchant is altered to be stateless or disconnected. Unless the user reconnects to process the transaction by entering their password, the POS machine will continue to process transactions for other user/customers in queue. The transaction for a user will be cancelled if the user does not reconnect and enter their password to authorize payment for the transaction within the specified time limit.

If the user enters the password, the telecom service provider authorizes payment from the financial account or mobile currency of the customer to the payment system of the merchant 408. The merchant payment system receives funds which are transferred into a POS merchant account to satisfy the invoice amount of the transaction 410.

Once the payment is authorized by the telecom service provider, the merchant and the user are notified and a paid invoice is generated 412.

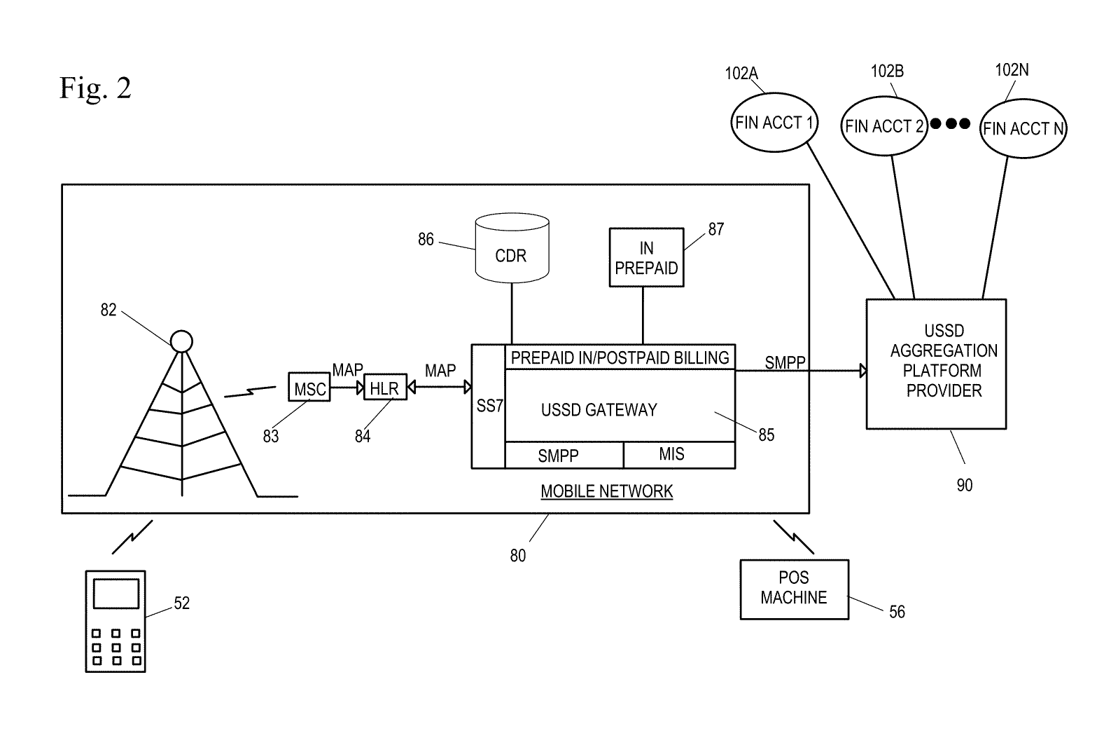

FIG. 2 shows a block diagram of how the USSD menu is sent to a mobile device. A USSD gateway 85 resides as an application in a mobile network 80 of a telecom service provider. The USSD gateway 85 may reside in a mobile switching center (MSC) 83, home location register (HLR) 84, visitor location register (VLR) (not shown) on the mobile network 80. The USSD gateway may communicate with an independent server such as the USSD aggregation platform provider 90 that is connected to the mobile network 80, for example by using short message peer-to-peer (SMPP). It should be noted that while USSD is used herein, the USSD protocol itself is defined as part of the GSM standard, and does not form part of this invention. The USSD aggregation platform provider 90 is a platform for communication between multiple banks or financial institutions and associated accounts and the telecom service provider. . The financial institution may be a bank, mobile account currency, or any other financial institution which provides a facility for the storage of money The USSD aggregation platform 90 may be based on any protocol, such as a HTTP, simple mail transfer protocol (SMTP), simple access object protocol (SOAP), direct interaction with database (DB interface) or some other protocol.

The USSD gateway 85 communicates with components of the mobile network 80, for example using signaling system number seven (SS7) protocol through an application-layer. For example, a mobile application part (MAP) is a SS7 protocol that is used to communicate with the MSC 83 and the HLR 84, as well as other applications within the mobile network 80. A repository for call detail records (CDR) 86 as well as any prepaid monies (IN Prepaid) 87 may be in communication with the USSD gateway 85.

The POS machine 56 of the merchant causes the telecom service provider to initiate the USSD session between a specific user through their mobile phone number.

The USSD gateway 85 creates an interactive session between the telecom service provider and the user of the mobile device 52 for user authentication through a combination of requests and responses are transferred over the mobile network 80.

The authentication is network initiated and requires the user to provide a password. USSD gateways maintain a single interactive session between the user and the service provider once the connection is established.

The USSD gateway 85 maintains and destroys the sessions between the users and the telecom service providers, and manages the communications between the users and the merchants and the telecom service providers

Once the session is established, the USSD gateway 85 sends a USSD menu to the user's mobile device, for example through the MAP. The user responds to the USSD menu through the mobile device 52 by sending a menu choice using USSD, the USSD gateway communicates the choice to telecom service provider, which uses the choice to communicate with the merchant and/or the POS machine 56. The session may then be destroyed by the USSD gateway, or other USSD menus sent to the user as required.

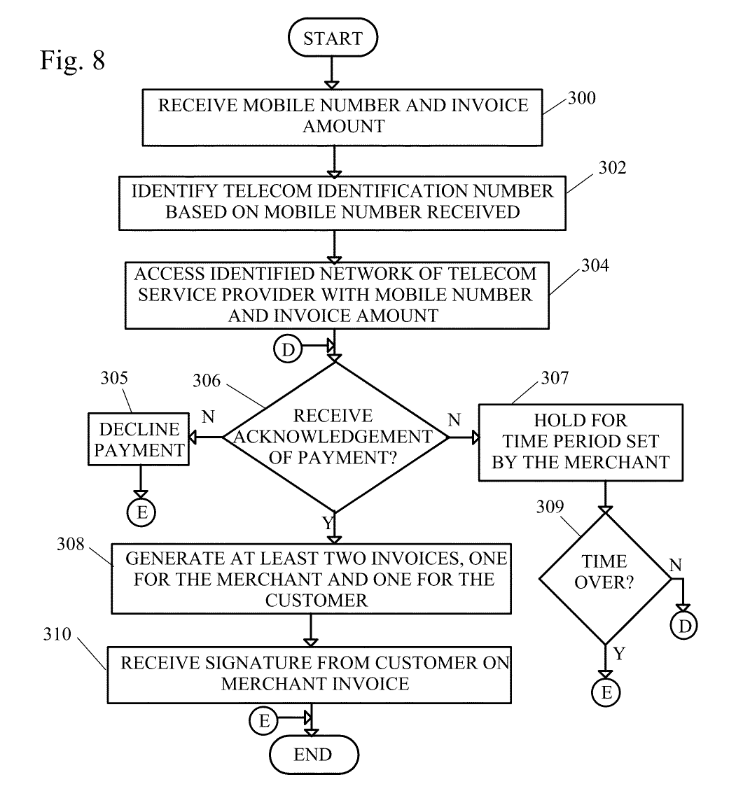

Prior to the steps of FIGS. 8-10, a customer registers and associates at least one financial account with a telecom service provider. A subscriber identification module (SIM) of the user's mobile device is associated by a telecom service provider with a user's account when the mobile device is registered with the telecom service provider. The SIM stores a mobile subscriber's identity and a related key used to identify and authenticate subscribers of a network run by the telecom service provider. The SIM may also include, for example, an integrated circuit card identifier, a unique serial number, security authentication ciphering information, temporary information related to the local network, a list of the services the user has access to, and any passwords.

The user's account is used to store, track, and receive payment for transactions related to the customer through the telecom service provider. The user registers at least one financial account with the telecom service provider associated with their account, for example through the interface 65 of the payment program 67, and the telecom service provider associates the registered financial account with the user's mobile phone number.

If a default account is not chosen by the user and more than one account has been registered, when an invoice from a POS machine initiates a session with the user's mobile device, a USSD menu will display all financial accounts registered. If a user has not selected a default account for payment, the first account listed on the menu is treated as the default account for payment. The USSD menu also preferably displays a balance amount available and associated with each financial account. The user can choose any of the accounts listed to pay for the invoice.

FIG. 8 shows a flow diagram of a method of remote authentication for point of sale (POS) machine using a mobile number.

A POS machine or POS computer 56, receives a mobile number and an invoice amount of a user (step 300), for example through a transaction and invoice program 64. The POS machine is preferably installed in a retail shop and includes an interface for accepting a mobile phone number of a customer or user. The interface may be a keypad or other interface.

A telecom identification number (TIN) of the telecom service provider is identified based on the mobile number received (step 302), for example by the transaction and invoice program 64. The TIN can be a mobile country code (MCC) used in combination with a mobile network code (MNC), also known as a MCC/MNC tuple. Alternatively, the TIN can be a set of USSD codes that the POS machine can use to connect to the user's telecom service provider. This TIN is helpful when the user needs to reconnect and access a transaction that was placed on hold. The TIN may also be provided to the user through a messaging service discussed below along with a one time purchase identification to allow the user to reconnect to the telecom service provide through a USSD gateway.

The POS machine then accesses the network of the identified telecom service provider based on the TIN, and sends the mobile number and invoice amount (step 304), for example by the transaction and invoice program 64. The TIN may also indicate other operational parameters required to complete the transaction. The parameters may include the data transfer rate, the line protocol, either synchronous or asynchronous data retrieval, and the type of encryption and the encryption key.

If the POS machine receives an acknowledgement regarding payment of the invoice amount from the customer financial account into the merchant account (step 306), the POS machine generates at least two invoices, one for the merchant and one for the customer (step 308), for example through the transaction and invoice program 64.

The POS machine then receives and stores a signature from the customer on or associated with the merchant invoice in a repository (step 310) and the method ends.

If the POS machine does not receive an acknowledgement regarding payment of the invoice amount from the customer financial account into the merchant account (step 306), the POS machine postpones or holds the transaction for a set time period (step 307).

If the time expires (step 309) and payment was not received, the method ends. If the time has not yet expired, the method returns to step 306 of determining whether an acknowledgement regarding payment was received.

If the POS machines does not receive an acknowledgement regarding payment of the invoice amount from the customer financial account into the merchant account (step 306) and instead receives a decline of payment or cancellation of the transaction (step 305), the method ends.

It should be noted that if an error occurs where the mobile number is not found or a loss of communication occurs, the transaction will be postponed or held for the time period set by the merchant (step 307) and the method continues from step 307.

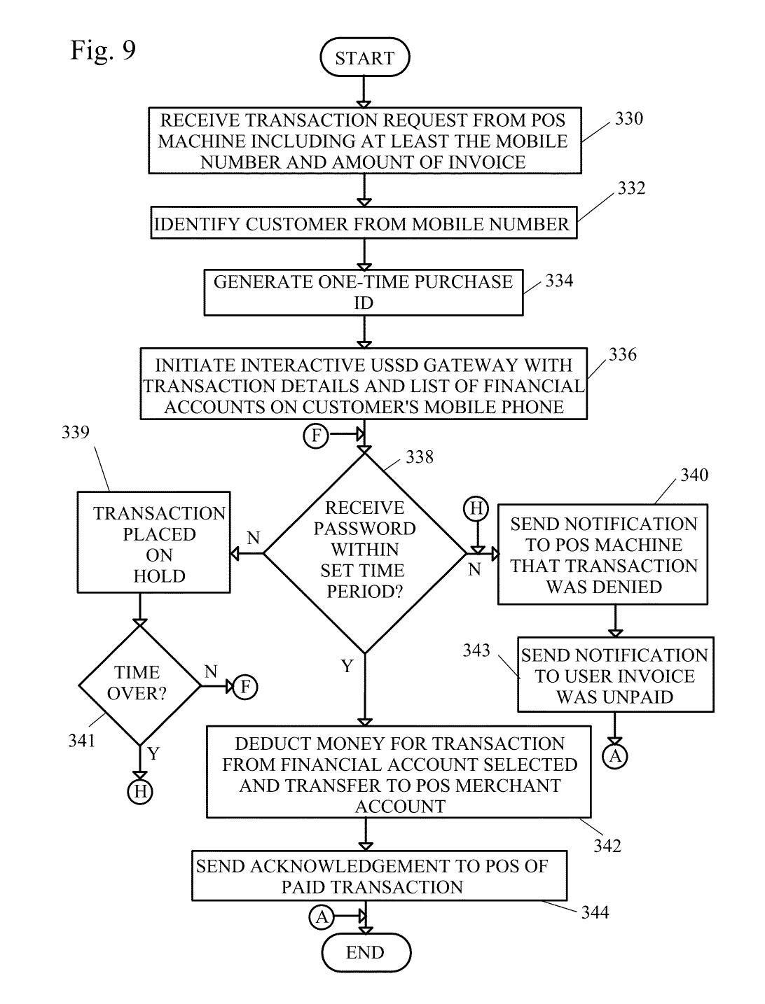

FIG. 9 shows a flow diagram of a method of obtaining remote authentication of a transaction through the telecom service provider. The telecom service provider receives a transaction request from a POS machine, including at least a mobile phone number and an invoice amount (step 330), for example through the payment program 67. A customer associated with the received mobile number is identified (step 332).

The telecom service provider generates a one-time purchase identification (ID) (step 334), for example through the payment program 67. The one-time purchase ID may be sent by short message service (SMS), or through other messaging services or e-mail, or as an image or voice message, prior to initiating the USSD gateway or within the USSD menu. The one-time purchase ID is used for purchasing identification. The one-time purchase ID is a randomly generated number which is valid for one transaction only. The one-time purchase ID can be used as a unique transaction identifier.

Sending the one-time purchase ID to the mobile device in a SMS or e-mail allows the user to finish whatever the user may be doing at the time the message is sent. For example, the user may be playing a game on the mobile device, conducting a conversation on the mobile device or completing some urgent work at the time of the USSD menu initiation on the mobile device. Alternatively, the user may accidently cancel the USSD menu. If the one-time purchase ID is available in an SMS or e-mail inbox, the user can reconnect back to USSD menu easily, making using of the TIN through the USSD gateway.

In addition to the one-time purchase ID, the SMS may contain an invoice amount, and details regarding the merchant, such as location of the merchant.

Alternatively, the one-time purchase ID and other details may also be sent through the USSD gateway 68 and be presented in the interactive menu, for example in step 336.

Furthermore, if a user receives multiple transaction requests at a time from different shops, to distinguish the transactions, all relevant information, such as merchant name, location, and other details would be provided along with one-time purchase ID indicating which purchase ID is associated with which transaction and retail shop of a merchant.

The telecom service provider then initiates an USSD gateway with an interactive menu with transaction details on the customer's mobile phone (step 336), for example through the USSD gateway 68. The transaction details may include, but is not limited to a one-time purchase ID, invoice amount, and details regarding the merchant.

If the telecom service provider receives the password from the user of the mobile phone within a set time period (step 338), the money for the invoice amount is deducted from the registered financial account for the user and transferred to a merchant account (step 342), for example by the payment program 67.

An acknowledgement is sent to the POS machine indicating that the invoice amount was paid (step 344), for example by the payment program 67 and the method ends.

If the telecom service provider does not receive the password from the user of the mobile phone within a set time period (step 338), a notification is sent to the POS machine that the transaction was denied (step 340), for example by the payment program 67 and another notification is sent to the user that the invoice was unpaid (step 343), for example by the payment program 67 and the method ends.

Alternatively, if the telecom service provider does not receive the password from the user of the mobile phone within a set time period (step 338), and does not receive a cancellation or an indication that the transaction was denied, the transaction is placed on hold for a time period established by the merchant (step 339) If the set time period is over (step 341), a notification is sent to the POS machine that the transaction was denied (step 340) and another a notification is sent to the user that the invoice was unpaid (step 343), for example by the payment program 67 and the method ends.

If the set time period (step 341) has not expired, the method returns to step 338 or determining whether the password has been received from the user of the mobile phone within a set time period.

It should be noted that if a user wanted to postpone or hold a transaction, the user can disconnect from a USSD session. Then, when they are ready to complete the transaction they can go to their SMS inbox on their mobile device and use the one-time purchase ID and their password to create a USSD session and authenticate the associated transaction request.

More than one transaction may be postponed and carried out by the user. The set time period to receive the password and approval of the transaction is preferably set by the merchant and may vary merchant to merchant, by amount of the invoice, type of goods being purchased, or other criteria.

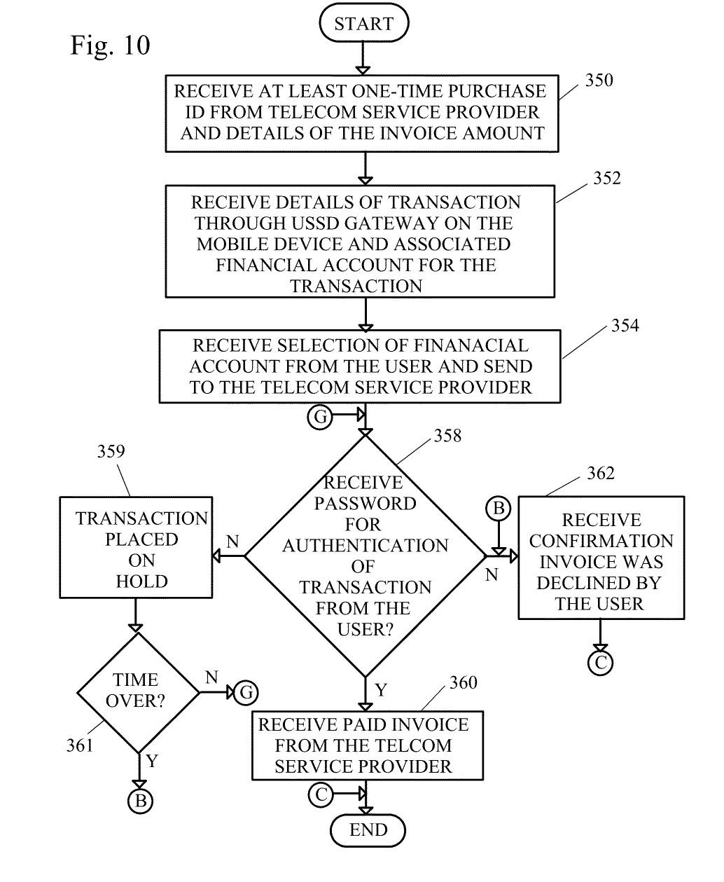

FIG. 10 shows a flow diagram of a method of remote authentication of a transaction through the customer's mobile phone using unstructured supplementary service data.

A customer's mobile device receives a one-time purchase ID from the telecom service provider (step 350), for example through the messaging program 66 or the USSD gateway 68.

The details of the transaction are received through the USSD gateway and are displayed on the mobile device along with associated financial accounts available to satisfy the invoice amount of the transaction being requested (step 352).

The selection of a financial account from the associated financial accounts available is received by the mobile device, through the USSD gateway and sent to the telecom service provider (step 354).

If the password is received by the USSD gateway to authenticate the transaction (step 358), for example through the USSD gateway 68, a paid invoice is received by the mobile phone (step 360) and the method ends.

If the password is not received by the USSD gateway (step 358), the mobile phone receives a confirmation that the invoice amount was unpaid (step 362) and the method ends.

If the telecom service provider does not receive the password from the user of the mobile phone within a set time period (step 358), the transaction is placed on hold (step 359). If the set time period is over (step 361), the telecom service provider receives confirmation that the invoice was declined by the user (step 362) and the method ends.

If the set time period (step 361) has not expired, the method returns to step 358 of determining whether the password has been received from the user of the mobile phone.

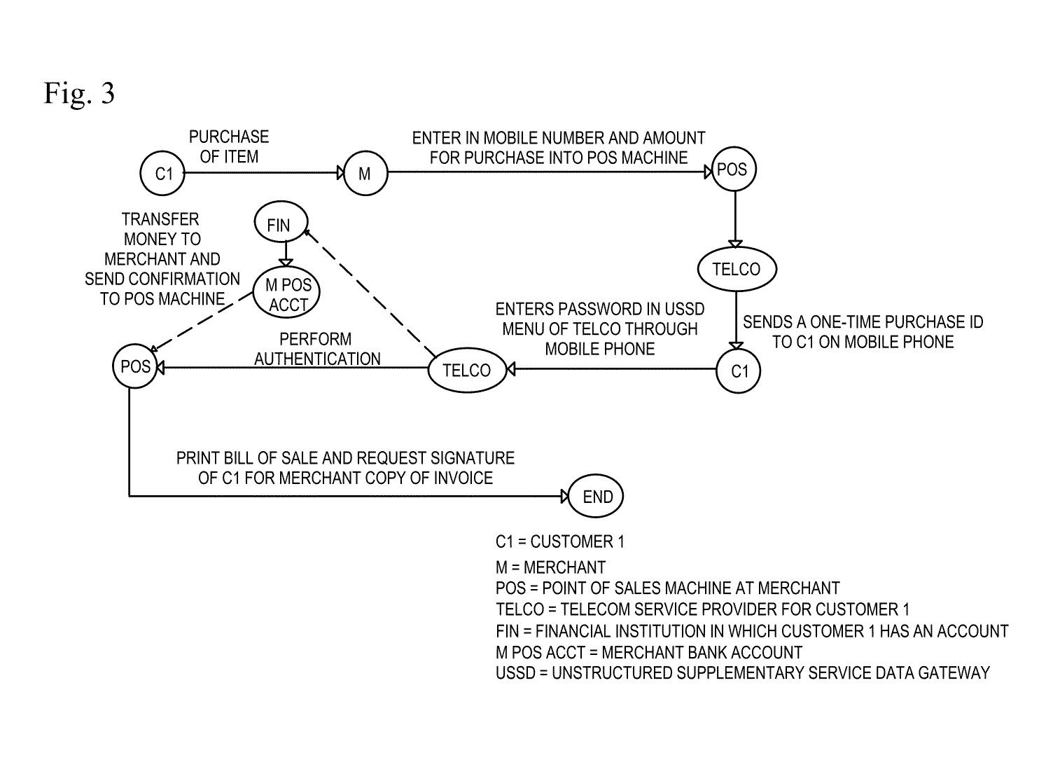

FIG. 3 shows an example of an interaction of a customer with merchant in a first embodiment using the method of FIGS. 8-10.

In this example, a customer (C1) wishes to purchase at least one item from a merchant (M). The customer (C1) is present at the retail shop. The merchant (M) enters in the mobile number of the customer (C1) and an amount for purchase or invoice amount into a POS machine (POS).

The POS machine (POS) notifies the telecom service provider (TELCO) associated with the mobile number entered. The telecom service provider (TELCO) sends a one-time purchase ID to the customer (C1) through the mobile device.

The customer (C1) enters their password in a USSD menu of a USSD gateway in a session initiated by the telecom service provider (TELCO) on the customer's mobile device.

The telecom service provider (TELCO) initiates the transfer of funds from the financial institution (FIN) to the merchant's POS bank account (M POS ACCT) and sends authentication to the POS machine (POS).

The POS machine (POS) prints a bill of sale and request a signature form the customer (C1) for a merchant copy of the invoice.

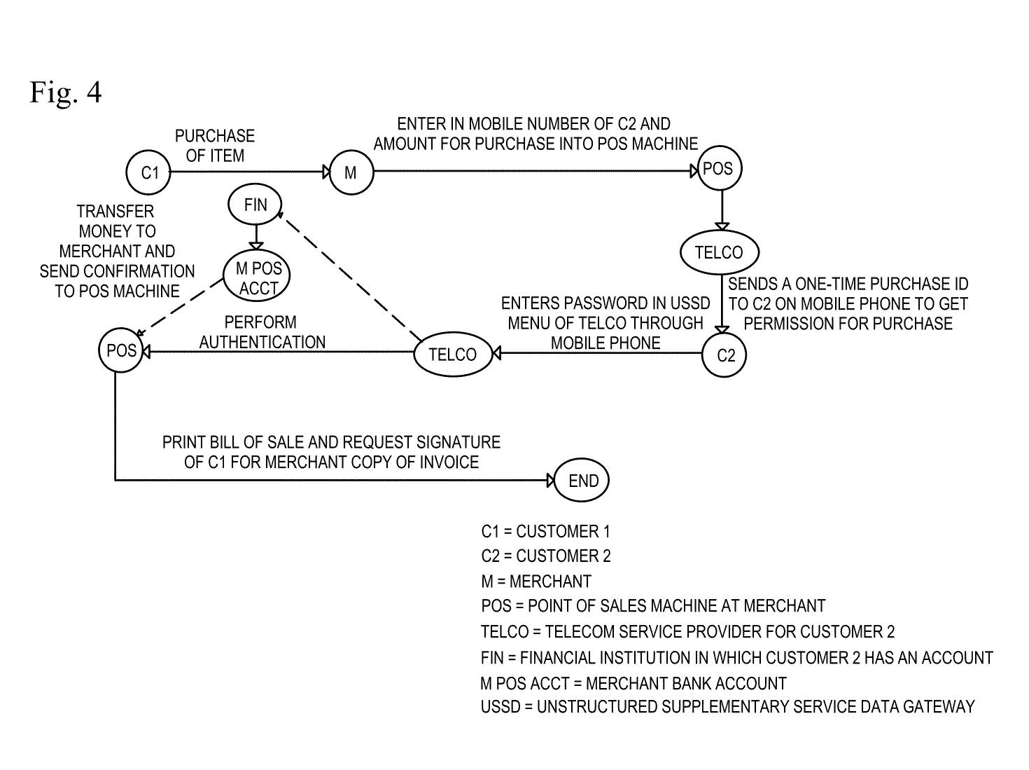

FIG. 4 shows an example of an interaction of a customer with merchant in a second embodiment using the method of FIGS. 8-10.

In this example, a customer (C1) wishes to purchase at least one item from a merchant (M). The customer (C1) is present at the retail shop, but customer (C2) is not, they are located remotely. The merchant (M) enters in the mobile number of another customer (C2) and an amount for purchase or invoice amount into a POS machine (POS). The other customer (C2) may be a family member or other individual who is going to pay the invoice remotely.

The POS machine (POS) notifies the telecom service provider (TELCO) associated with the mobile number entered by the merchant into the POS machine.

The telecom service provider (TELCO) sends a one-time purchase ID to the other customer (C2) through the mobile device. The other customer (C2) enters their password in a USSD menu of a USSD gateway initiated by the telecom service provider (TELCO) on the customer's mobile device.

The telecom service provider (TELCO) initiates the transfer of funds from the financial institution (FIN) to the merchant's POS financial account (M POS ACCT) and sends authentication to the POS machine (POS).

The POS machine (POS) prints a bill of sale and request a signature from the customer (C1) for a merchant copy of the invoice. A copy of the invoice may also be sent to the other customer (C2).

Alternatively, if the other customer (C2) is not able to immediately provide their password for authentication of the transaction, the transaction may be postponed or held. The user may disconnect from a USSD session and reconnect later using their password and the one-time purchase ID.

In the event of mobile device theft or mobile device loss, details regarding transactions and USSD sessions are not stored on the mobile device (unlike a mobile banking or payment application) and therefore sensitive data relating to the user's financial account or transactions are not present for the thief. Remote authentication privileges may be turned on and off through the telecom service provider, preventing any transaction from proceeding after the theft or loss of the mobile device.

Furthermore, the thief would need to have the knowledge of the mobile number of the mobile device, the mobile phone owner's password to carry out a transaction and the SIM card associated with the mobile number. If the password only allows three incorrect entries prior to locking the user out.

FIG. 11 illustrates internal and external components of a mobile device computer 52, a telecom service provider 55, a POS machine 56, a financial institution computer 59, and a server computer 54 in which illustrative embodiments may be implemented. In FIG. 11, mobile device computer 52, POS computer 56, a server computer 54, and a telecom service provider 55 include respective sets of internal components 800a, 800b. 800c, 800d, 800e and external components 900a, 900b, 900c, 900d, 900e. Each of the sets of internal components 800a, 800b, 800c, 800d, 800e includes one or more processors 820, one or more computer-readable RAMs 822 and one or more computer-readable ROMs 824 on one or more buses 826, and one or more operating systems 828 and one or more computer-readable tangible storage devices 830.

The one or more operating systems 828, USSD gateway 68, a messaging program 66, a transaction and invoice program 64, and a payment program 67 are stored on one or more of the computer-readable tangible storage devices 830 for execution by one or more of the processors 820 via one or more of the RAMs 822 (which typically include cache memory). In the embodiment illustrated in FIG. 11, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b, 800c, 800d, 800e also includes a R/W drive or interface 832 to read from and write to one or more portable computer-readable tangible storage devices 936 such as a CD-ROM, DVD, memory stick, magnetic tape, magnetic disk, optical disk or semiconductor storage device. Messaging program 66, USSD gateway 68, transaction and invoice program 64, and payment program 67 can be stored on one or more of the portable computer-readable tangible storage devices 936, read via R/W drive or interface 832 and loaded into hard drive 830.

Each set of internal components 800a, 800b, 800c, 800d, 800e also includes a network adapter or interface 836 such as a TCP/IP adapter card.

Messaging program 66 can be downloaded to the mobile device computer 52 and server computer 54 from an external computer via a network (for example, the Internet, a local area network or other, wide area network) and network adapter or interface 836. From the network adapter or interface 836, messaging program 66 are loaded into hard drive 830. The network may comprise copper wires, optical fibers, wireless transmission, routers, firewalls, switches, gateway computers and/or edge servers.

Transaction and invoice program 64 can be downloaded to the POS computer 56 and server computer 54 from an external computer via a network (for example, the Internet, a local area network or other, wide area network) and network adapter or interface 836. From the network adapter or interface 836, transaction and invoice program 64 are loaded into hard drive 830. The network may comprise copper wires, optical fibers, wireless transmission, routers, firewalls, switches, gateway computers and/or edge servers.

Payment program 67 and USSD gateway 68 can be downloaded to the telecom service provider device computer 55 and server computer 54 from an external computer via a network (for example, the Internet, a local area network or other, wide area network) and network adapter or interface 836. From the network adapter or interface 836, USSD gateway 68 and payment program 67 are loaded into hard drive 830. The network may comprise copper wires, optical fibers, wireless transmission, routers, firewalls, switches, gateway computers and/or edge servers.

Each of the sets of external components 900a, 900b, 900c, 900d, 900e includes a computer display monitor 920, a keyboard 930, and a computer mouse 934. Each of the sets of internal components 800a, 800b, 800c, 800d, 800e also includes device drivers 840 to interface to computer display monitor 920, keyboard 930 and computer mouse 934. The device drivers 840, R/W drive or interface 832 and network adapter or interface 836 comprise hardware and software (stored in storage device 830 and/or ROM 824).

Messaging program 66, USSD gateway 68, transaction and invoice program 64, and payment program 67 can be written in various programming languages including low-level, high-level, object-oriented or non object-oriented languages. Alternatively, the functions of a messaging program 66, a USSD gateway 68, a transaction and invoice program 64, and a payment program 67 can be implemented in whole or in part by computer circuits and other hardware (not shown).

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having thus described the invention of the present application in detail and by reference to embodiments thereof, it will be apparent that modifications and variations are possible without departing from the scope of the invention defined in the appended claims.

What is claimed is:

1. A method of a user remotely authenticating an invoice amount for a sales transaction with a merchant through a mobile device using an unstructured supplementary service data session initiated by a telecom service provider, the method comprising the steps of:
the telecom service provider receiving a transaction request comprising at least a mobile phone number and the invoice amount from a point of sale machine at the merchant;
the telecom service provider identifying the user from the mobile phone number received;
the telecom service provider generating a one-time purchase identification associated with the invoice and sending the one-time purchase identification to the user through the mobile device;
the telecom service provider initiating an interactive unstructured supplementary service data session with the user through a gateway;
the telecom service provider sending a menu with transaction details on the user's mobile device through the data session;
the telecom service provider receiving a password from the user through the unstructured supplementary service data session, deducting the invoice amount from a financial account associated with the user and transferring the invoice amount to a financial account associated with the merchant; and
the telecom service provider sending an acknowledgement of payment of the invoice to the point of sale machine.

2. The method of claim 1, further comprising the step of the telecom service provider placing the transaction on hold after a specified time period without receiving the password from the user.

3. The method of claim 1, further comprising the step of the telecom service provider placing the transaction on hold when the user is engaged with the mobile phone.

4. The method of claim 1, wherein the telecom service provider is connected to the point of sale machine through Internet using a telecom identification number.

5. The method of claim 1, wherein the telecom service provider is connected to the point of sale machine through a unstructured supplementary service data session using a telecom identification number.

6. The method of claim 1, wherein the one-time purchase identification is sent to the mobile device via a message outside the unstructured supplementary service data session.

7. The method of claim 1, wherein the one-time purchase identification is sent to the mobile device via the unstructured supplementary service data gateway.

8. The method of claim 1, wherein the method further comprises the step of the telecom service provider receiving a choice from the user of a financial account out of a plurality of financial accounts associated with the mobile number of the user, from which to transfer the invoice amount to the financial account associated with the merchant.

9. The method of claim 1, wherein the user is present at the merchant.

10. The method of claim 1, wherein the user having the mobile device is not present at the merchant, and the sales transaction is initiated by another customer present at the merchant giving the mobile phone number associated with the user to the merchant.

11. The method of claim 1, in which if the telecom service provider does not receive the password within a specified time limit, the method ends.

12. A computer program product for a user to remotely authenticating an invoice amount for a sales transaction with a merchant through a mobile device using an unstructured supplementary service data session initiated by a telecom service provider comprising a telecom service provider computer comprising at least one processor, one or more memories, one or more computer readable storage media, the computer program product comprising a computer readable storage medium having program instructions embodied therewith, the program instructions executable by the computer to perform a method comprising:
receiving, by the telecom service provider computer, a transaction request comprising at least a mobile phone number and the invoice amount from a point of sale machine at the merchant;
identifying, by the telecom service provider computer, the user from the mobile phone number received;
generating, by the telecom service provider computer, a one-time purchase identification associated with the invoice and sending the one-time purchase identification to the user through the mobile device;
initiating, by the telecom service provider computer, an interactive unstructured supplementary service data session with the user through a gateway;
sending, by the telecom service provider computer, a menu with transaction details on the user's mobile device through the unstructured supplementary service data session;
receiving, by the telecom service provider computer, a password from the user through the unstructured supplementary service data session, deducting the invoice amount from a financial account associated with the user and transferring the invoice amount to a financial account associated with the merchant; and
sending, by the telecom service provider computer, an acknowledgement of payment of the invoice to the point of sale machine.

13. The computer program product of claim 12, wherein the program instructions further comprises receiving, by the telecom service provider, a choice from the user of a money account out of a plurality of money accounts associated with the mobile number of the user, from which to transfer the invoice amount to the financial account associated with the merchant.

14. The computer program product of claim 12, wherein the user is present at the merchant.

15. The computer program product of claim 12, wherein the user having the mobile device is not present at the merchant, and the sales transaction is initiated by another customer present at the merchant giving the mobile phone number associated with the user to the merchant.

16. The computer program product of claim 12, in which if the telecom service provider does not receive the password within a specified time limit, the program instructions end.

17. A computer system for a user to remotely authenticating an invoice amount for a sales transaction with a merchant through a mobile device using an unstructured supplementary service data session initiated by a telecom service provider comprising a telecom service provider computer comprising at least one processor, one or more memories, one or more computer readable storage media having program instructions executable by the computer to perform the program instructions comprising:
receiving, by the telecom service provider computer, a transaction request comprising at least a mobile phone number and the invoice amount from a point of sale machine at the merchant;
identifying, by the telecom service provider computer, the user from the mobile phone number received;
generating, by the telecom service provider computer, a one-time purchase identification associated with the invoice and sending the one-time purchase identification to the user through the mobile device;
initiating, by the telecom service provider computer, an interactive unstructured supplementary service data session with the user through a gateway;
sending, by the telecom service provider computer, a menu with transaction details on the user's mobile device through the unstructured supplementary service data session;
receiving, by the telecom service provider computer, a password from the user through the data session, deducting the invoice amount from a financial account associated with the user and transferring the invoice amount to a financial account associated with the merchant; and
sending, by the telecom service provider computer, an acknowledgement of payment of the invoice to the point of sale machine.

18. The computer system of claim 17, wherein the program instructions further comprises receiving, by the telecom service provider, a choice from the user of a money account out of a plurality of money accounts associated with the mobile number of the user, from which to transfer the invoice amount to the financial account associated with the merchant.

19. The computer system of claim 17, wherein the user is present at the merchant.

20. The computer system of claim 17, wherein the user having the mobile device is not present at the merchant, and the sales transaction is initiated by another customer present at the merchant giving the mobile phone number associated with the user to the merchant.
